(19) United States
(12) Patent Application Publication
(10) Pub. No.: US 2008/0224431 A1
(43) Pub. Date: Sep. 18, 2008

(54) Transport cart for a power tool

(76) Inventor: Tamara Reinicke, Kaufering (DE)

Correspondence Address: ABELMAN, FRAYNE & SCHWAB, 666 THIRD AVENUE, 10TH FLOOR, NEW YORK, NY, 10017, US

(21) Appl. No.: 12/074,661

(22) Filed: Mar. 4, 2008

(30) Foreign Application Priority Data
Mar. 5, 2007 (DE) 10 2007 000 127.6

(51) Int. Cl. B62B 1/22

(52) U.S. Cl. 280/47.26

(57) ABSTRACT

A transport cart (10) for a power tool has at least two wheels (11) arranged coaxial to one another, a load-carrying construction (12), a guide construction (15) having at least one handle (16) and connected to the load-carrying construction (12), and a holding device (20) for tools (30) and having at least one receptacle (21). The holding device (20) is formed of at least a first profiled sheet part (22, 23) and a counter-support part which is arranged opposite to the first profiled sheet part (22, 23) and which is connected to the latter at at least two connection points (24, 25), with the at least one receptacle (21) being formed by at least one profile pocket (26) of the profiled sheet part (22, 23).

### BACKGROUND OF THE INVENTION

1. Field of the Invention

The invention relates to a transport cart for a power tool and including at least two wheels arranged coaxially to one another a load-carrying construction a guide construction having at least one handle and being connected to the load-carrying construction and a holding device for the power tool having at least one receptacle.

2. Description of the Prior Art

Transport carts of this kind are used for transporting power tools and working tools such as, e.g., a chisel that can be used with the power tool.

DE 295 506 638 U discloses a transporting and service cart having a load-carrying construction, which is supported on the ground by two wheels and provided with support legs at its free end, and a guide construction which is arranged so as to rise above the wheel axle and which has stirrup-shaped handles or handles which are arranged at or formed at bars. Further, the transport cart has at the guide construction at least one stiffening cross-piece which connects the vertical bars to one another, and at least one additional guide strut for a vertically adjustable stirrup-shaped arrangement is provided between the vertical bars so as to be oriented parallel to the bars. A holding device for tools or accessories which has a series of insertion receptacles in the form of bore holes is provided transversely between the bars.

It is disadvantageous in the known transport cart that working tools which are inserted into the insertion receptacles can easily be bounced out of the insertion receptacles when the transport cart moves over an uneven or bumpy surface. This is very bothersome for the user of a transport cart of this kind.

### SUMMARY OF THE INVENTION

It is the object of the present invention to provide a transport cart with a holding device for tools that avoids the above-mentioned disadvantages and allows tools of different shank diameters to be transported and stored.

According to the invention, this and other objects of the present invention, which will become apparent hereinafter, are achieved by forming the holding device of at least a first profiled sheet part and a counter-support part which is arranged opposite the profiled sheet part and which is connected to the latter at at least two connection points, with the at least one receptacle being formed by at least one profile pocket of the profiled sheet part. The profiled sheet part contacts the counter-support part in at least some areas. The counter-support part can be constructed, for example, as a sheet part, a strut, a frame element, or the like, and can be part of the guide construction of the transport cart, for example. The at least one profiled sheet part has a certain inherent elasticity and is biased toward the counter-support part so that a working tool inserted into a receptacle is also held therein in a frictional engagement and in a clamping manner. In this way, a tool located in the receptacle is reliably prevented from slipping out during transportation. Further, the receptacle which is formed by the profile pockets can be elastically expanded, e.g., when working tools with larger shank diameters are inserted therein. Further, the holding device according to the invention is very economical because it can be realized with a few parts that are easy to manufacture. The at least one profiled sheet part can be formed of sheet steel or plastic sheet, for example.

The counter-support part is advantageously designed as a second profiled sheet part which succeeds in holding tools of different shank diameters in a highly flexible manner.

Further, it is advantageous when the first profiled sheet part and the second profiled sheet part are arranged so as to be mirror-symmetrical to one another in a plane E so as to produce isometric receptacles.

The profiled sheet parts are advantageously formed as sheets with trapezoidal corrugations which are highly elastic and economical to produce.

The least one receptacle is advantageously formed by two profile pockets located opposite one another along a plane so that at least one symmetrical cylindrical receptacle is formed.

It is also advantageous when first and second connection points are provided and flexible connection elements are arranged at least at the second connection points for connecting the two profiled sheet parts to one another. This provides receptacles which are highly elastic and expandable in direction perpendicular to the cylinder axis of the receptacles, which makes it possible for tools with different shank diameters to be held in the receptacles.

In an advantageous construction of the invention, flexible connection elements are formed as U-shaped or fork-shaped spring clip elements which are economical and easy to mount.

The profiled sheet parts are advantageously connected to one another and to the guide construction, e.g., to the bars of the guide construction, at the first connection points. Depending on the design of the guide construction, the first connection points can be arranged at the two ends of the profiled sheet parts extending in longitudinal direction. The connection points can be weld connections, solder connections, screw connections, glue connections, or rivet connections, for example.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a perspective view of a transport cart according to the invention;

FIG. 2 a perspective view of the holding device of the transport cart shown in FIG. 1;

FIG. 3 a cross-sectional view of the holding device along line III-III in FIG. 2; and

FIG. 4 a perspective view of spring clip of the holding device according to FIGS. 1 to 3.

### DETAILED DESCRIPTION OF THE PREFERRED EMBODIMENTS

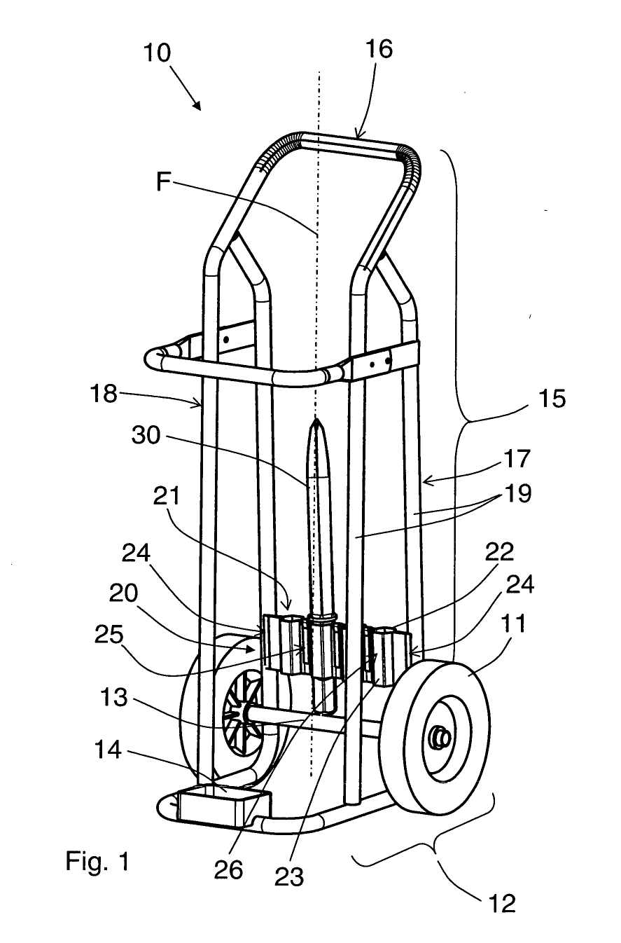

FIG. 1 shows a transport cart 10 according to the present invention and having a stirrup-shaped load-carrying construction 12 to which a box-shaped load receptacle 14 is secured. The load-carrying construction 12 is formed, e.g., of steel pipes and is fixedly connected to a guide construction 15 which projects from the load-carrying construction 12 and has two side parts 17, 18 each of which comprises two bars 19. The bars 19 have, at their end remote from the load-carrying construction 12, a stirrup-shaped handle 16 which connects the two side parts 17, 18 to one another. The guide construction 15 is likewise made of steel pipe, for example. In the area of the transition from the load-carrying construction 12 to the guide construction 15, a transverse connector 13 is arranged. Wheels 11 which support the transport cart 10 on the ground are mounted at the two axial ends of the transverse connector 13.

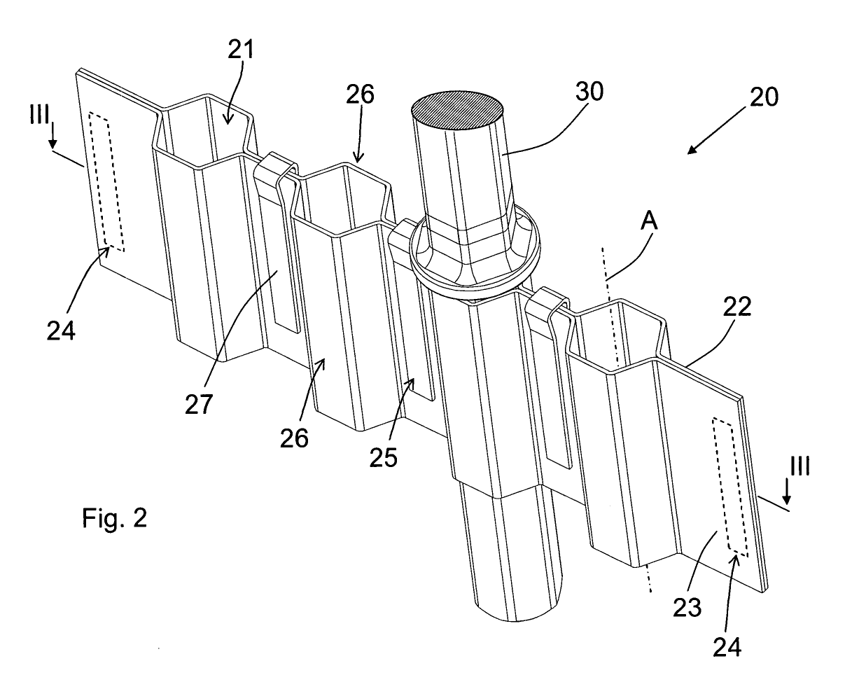

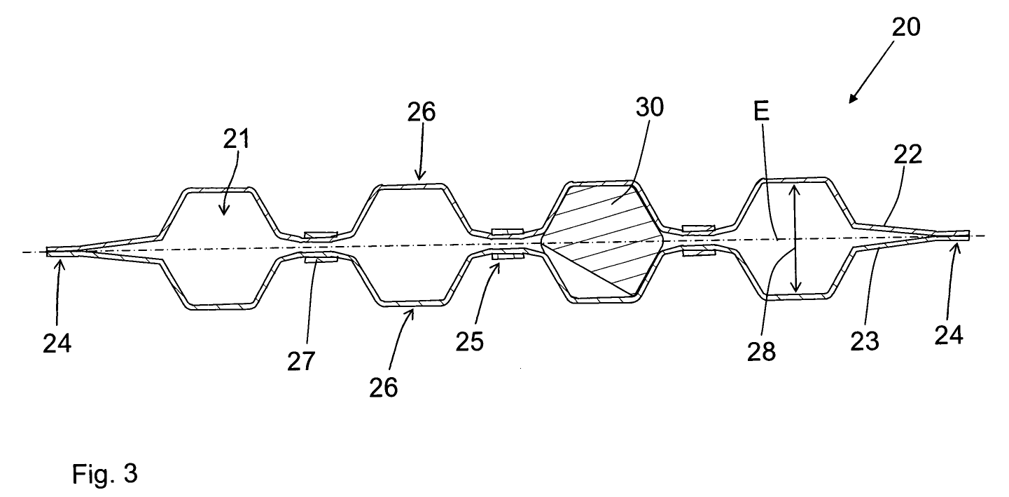

Further, the transport cart 10 has a holding device, designated in its entirety by a reference numeral 20, which forms a plurality of cylindrical receptacles 21 for tools 30 and which will be described more fully with reference to FIGS. 2 and 3. The holding device 20 has a first profiled sheet part 22 which is arranged mirror-symmetrically to a counter-support part along a plane E, this counter-support part being formed as second profiled sheet part 23. The profiled sheet parts 22, 23 can be made of steel or of sheet plastic, for example, and are shaped as sheets with trapezoidal corrugations, for example. At first connection points 24 which are formed at end areas of the profiled sheet parts 22, 23 that lie in longitudinal direction of the profiled sheet parts 22, 23, the profiled sheet parts 22, 23 are fixedly connected to one another and are also secured to two bars 19 of the guide construction 15 which are located opposite one another. The securing of the structural component parts are fixed to one another, for example, by means of a weld connection or solder connection. An additional transverse stiffening of the guide construction 15 and of the transport cart 10 is achieved by connecting the bars 19 of the two oppositely located side parts 17, 18 to one another by means of the holding device 20.

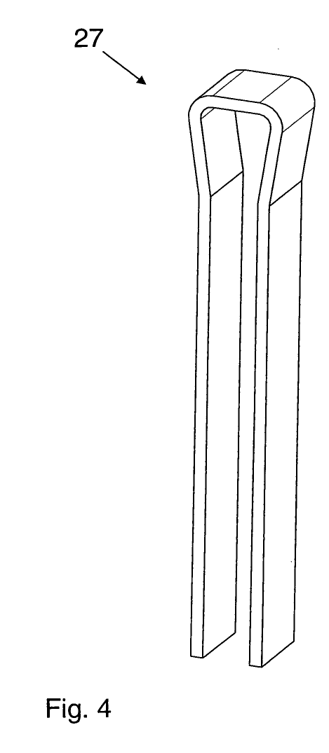

The profiled sheet parts 22, 23 have elongated half-cylindrical profile pockets 26 which are oriented transverse to the longitudinal direction of the profiled sheet parts 22, 23. The profile pockets 26 are mirror-symmetrical to one another along the plane E so that they form a cylindrical receptacle 21 for tools 30. By cylindrical is meant, within the meaning of the invention, that the receptacle is formed as a hollow space extending along a longitudinal axis and enclosed by walls and can have a substantially polygonal (symmetric or asymmetric) cross-section as well as a circular or oval cross-section. The receptacles 21, four of which are provided in the embodiment shown in the drawings, respectively define a cylinder axis A which extends approximately in longitudinal direction F of the guide construction 15 (compare FIGS. 1 and 2). Second connection points 25 are arranged in areas located between the receptacles 21, at which areas the profiled sheet parts 22, 23 lie relatively close together (particularly when there is no tool 30 inserted into one of the receptacles 21), the two profiled sheet parts 22, 23 being elastically connected to one another at the second connection points 25 by means of flexible connection elements 27 (see FIG. 4) which are formed as elongated spring clip elements. In this way and also due to the inherent elasticity of the profiled sheet parts 22, 23, an extensive elasticity and expandability of the receptacles 21 is achieved as a whole in a direction perpendicular to the cylinder axis A of the receptacles 21 (indicated by double arrow 28 in FIG. 3), which makes it possible for tools 30 with different shank diameters to be held in the receptacles 21.

As can be seen in particular from FIG. 3, the two profiled sheet parts 22, 23 are stretched apart in both directions indicated by the double arrow 28 when a tool 30 is inserted whose shank diameter or shank cross-section exceeds the maximum opening cross-section or diameter of the receptacles 21 in the initial position (without the tool inserted). The tool 30 is now held not only in a positive engagement (by the collar of the tool 30 which is supported in the receptacle 21 at the edges surrounding the receptacle 21; compare FIGS. 1 and 2), but also by a frictional engagement.

Though the present invention was shown and described with reference to the preferred embodiment, such is merely illustrative of the present invention and is not to be construed as a limitation thereof, and various modifications of the present invention will be apparent to those skilled in the art. It is, therefore, not intended that the present invention be limited to disclose the embodiment or details thereof, and the present invention includes all variations and/or alternative embodiments within the spirit and scope of the present invention as defined by the appended claims.

What is claimed is:

1. A transport cart (10) for a power tool, comprising at least two wheels (11) arranged coaxially to one another; a load-carrying construction (12); a guide construction (15) having at least one handle (16) and being connected to the load-carrying construction (12); and a holding device (20) for tools (30) having at least one receptacle (21) formed of at least a first profiled sheet part (22, 23) and a counter-support part which is arranged opposite to the first profiled sheet part (22, 23) and which is connected to the latter at at least two connection points (24, 25), with the at least one receptacle (21) being formed by at least one profile pocket (26) of the profiled sheet part (22, 23).

2. A transport cart according to claim 1, wherein the counter-support part is formed as a second profiled sheet part (23).

3. A transport cart according to claim 2, wherein the first profiled sheet part (22) and the second profiled sheet part (23) are arranged so as to be mirror-symmetrical to one another along a plane E.

4. A transport cart according to claim 2, wherein the first profiled sheet part (22, 23) is formed as a sheet with trapezoidal corrugations.

5. A transport cart according to claim 4, wherein the second profiled sheet (22, 23) is also formed as a sheet with trapezoidal corrugations.

6. A transport cart according to claim 1, wherein the least one receptacle (21) is formed by two profile pockets (26) located opposite one another along a plane (E).

7. A transport cart according to claim 2, wherein there are provided first and second connection points (24, 25), and wherein flexible connection elements (27) are arranged at least at the second connection points (25) for connecting the two profiled sheet parts (22, 23) to one another.

8. A transport cart according to claim 1, wherein the flexible connection elements (27) are formed as spring clip elements.

9. A transport cart according to claim 2, wherein the first and second profiled sheet parts (22, 23) are connected to one another and to the guide construction (15) at the first connection points (24).
